(19) United States
(12) Patent Application Publication
(10) Pub. No.: US 2026/0332743 A1
(43) Pub. Date: Oct. 22, 2026

(54) METHOD AND APPARATUS FOR VIDEO CODING

(71) Applicant: MEDIATEK INC., Hsinchu City (TW)

(72) Inventors: Olena CHUBACH, San Jose, CA (US); Yi-Wen CHEN, San Jose, CA (US); Ching-Yeh CHEN, Hsinchu City (TW)

(21) Appl. No.: 19/106,736

(22) PCT Filed: Sep. 22, 2023
(86) PCT No.: PCT/CN2023/120828

§ 371 Date: Feb. 26, 2025

Related U.S. Application Data
(60) Provisional application No. 63/376,627, filed on Sep. 22, 2022.

(51) Int. Cl. H04N 19/105; H04N 19/159; H04N 19/176; H04N 19/196; H04N 19/513; H04N 19/573; H04N 19/577

(52) U.S. Cl. CPC H04N 19/105; H04N 19/159; H04N 19/176; H04N 19/196; H04N 19/521; H04N 19/573; H04N 19/577

(57) ABSTRACT

Aspects of the disclosure provide methods, apparatuses, and non-transitory computer-readable storage medium for video coding. An apparatus includes processing circuitry that decodes prediction information of a current block indicating a bi-directional prediction for the current block. The processing circuitry determines two reference blocks for the current block. When the two reference blocks are across boundaries of reference pictures, the processing circuitry determines a part of the current block corresponding to two parts of the two reference blocks outside the boundaries of the reference pictures. The processing circuitry decodes the current block by predicting the part of the current block based on one of a uni-prediction and a bi-prediction. The uni-prediction uses samples of a predictor from one of the two reference blocks inside the boundary of one of the reference pictures, and the bi-prediction uses samples of predictors from the two reference blocks inside the boundaries of the reference pictures.

### INCORPORATION BY REFERENCE

This present disclosure claims the benefit of priority to U.S. Provisional Application No. 63/376,627, “OOB SPECIAL CASES HANDLING” filed on Sep. 22, 2022, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

One purpose of video coding (e.g., encoding and/or decoding) can be a reduction of redundancy in an input video signal, through a compression. The compression can help reduce bandwidth or storage space requirements. Both lossless and lossy compression, as well as a combination thereof can be employed.

Video coding can be performed using an inter-picture prediction with motion compensation. Motion compensation can be a lossy compression technique and can relate to techniques where a block of sample data from a previously reconstructed picture or part thereof (reference picture), after being spatially shifted in a direction indicated by a motion vector (MV henceforth), is used for the prediction of a newly reconstructed picture or picture part.

### SUMMARY

Aspects of the disclosure provide a method for video decoding at a decoder. The decoding method includes decoding prediction information of a current block in a current picture of a video sequence. The prediction information indicates a bi-directional prediction for the current block. The decoding method includes determining two reference blocks of the bi-directional prediction for the current block. In response to both the reference blocks of the bi-directional prediction being across boundaries of reference pictures of the reference blocks, the decoding method includes determining a part of the current block that corresponds to two parts of the two reference blocks each outside the boundary of the respective reference picture. The decoding method includes decoding the current block by predicting the part of the current block based on one of a uni-prediction and a bi-prediction. The uni-prediction uses samples of a predictor from one of the two reference blocks inside the boundary of one of the reference pictures, and the bi-prediction uses samples of predictors from the two reference blocks inside the boundaries of the reference pictures.

In an embodiment, the decoding method includes determining whether one of the two reference blocks is across a corner of the reference picture of the one of the two reference blocks. In response to one of the two reference blocks being across the corner of the reference picture of the one of the two reference blocks, the decoding method includes decoding the current block by predicting the whole current block based on the bi-prediction using the samples of the predictors from the two reference blocks inside the boundaries of the reference pictures.

In an embodiment, the decoding method includes determining whether the boundaries of the two reference pictures that the two reference blocks are across are at different sides of the two reference pictures. In response to the boundaries of the two reference pictures that the two reference blocks are across being at different sides of the two reference pictures, the decoding method includes decoding the current block by predicting the whole current block based on the bi-prediction using the samples of the predictors from the two reference blocks inside the boundaries of the reference pictures. In response to the boundaries of the two reference pictures that the two reference blocks are across being at the same sides of the two reference pictures, the decoding method includes decoding the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

In an embodiment, in response to two uni-predictions being available for the current block, the decoding method includes decoding the current block by predicting the part of the current block based on a comparison of sizes of two out-of-boundary (OOB) areas each corresponding to one of the two uni-predictions. In response to the sizes of the two OOB areas corresponding to the two uni-predictions being the same, the decoding method includes decoding the current block by predicting the part of the current block based on one of the two uni-predictions that is predetermined.

In an embodiment, the decoding method includes determining that at least one of multi-pass decoder-side motion vector refinement (MPDMVR) tool or bi-directional optical flow (BDOF) tool is disallowed for the current block.

In an embodiment, the two reference pictures are the same reference picture.

In an embodiment, the two reference pictures are different reference pictures.

Aspects of the disclosure provide an apparatus for video decoding. The apparatus includes processing circuitry that decodes prediction information of a current block in a current picture of a video sequence. The prediction information indicates a bi-directional prediction for the current block. The processing circuitry determines two reference blocks of the bi-directional prediction for the current block. In response to both the reference blocks of the bi-directional prediction being across boundaries of reference pictures of the reference blocks, the processing circuitry determines a part of the current block that corresponds to two parts of the two reference blocks each outside the boundary of the respective reference picture. The processing circuitry decodes the current block by predicting the part of the current block based on one of a uni-prediction and a bi-prediction. The uni-prediction uses samples of a predictor from one of the two reference blocks inside the boundary of one of the reference pictures, and the bi-prediction uses samples of predictors from the two reference blocks inside the boundaries of the reference pictures.

In an embodiment, the processing circuitry determines whether one of the two reference blocks is across a corner of the reference picture of the one of the two reference blocks. In response to one of the two reference blocks being across the corner of the reference picture of the one of the two reference blocks, the processing circuitry decodes the current block by predicting the whole current block based on the bi-prediction using the samples of the predictors from the two reference blocks inside the boundaries of the reference pictures.

In an embodiment, the processing circuitry determines whether the boundaries of the two reference pictures that the two reference blocks are across are at different sides of the two reference pictures. In response to the boundaries of the two reference pictures that the two reference blocks are across being at different sides of the two reference pictures, the processing circuitry decodes the current block by predicting the whole current block based on the bi-prediction using the samples of the predictors from the two reference blocks inside the boundaries of the reference pictures. In response to the boundaries of the two reference pictures that the two reference blocks are across being at the same sides of the two reference pictures, the processing circuitry decodes the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

In an embodiment, in response to two uni-predictions being available for the current block, the processing circuitry decode the current block by predicting the part of the current block based on a comparison of sizes of two OOB areas each corresponding to one of the two uni-predictions.

In an embodiment, in response to the sizes of the two OOB areas corresponding to two uni-predictions being the same, the processing circuitry decodes the current block by predicting the part of the current block based on one of the two uni-predictions that is predetermined.

In an embodiment, the processing circuitry determines that at least one of MPDMVR tool or BDOF tool is disallowed for the current block.

In an embodiment, the two reference pictures are the same reference picture.

In an embodiment, the two reference pictures are different reference pictures.

Aspects of the disclosure provide a method of video encoding at an encoder. The encoding method includes generating prediction information of a current block in a current picture of a video sequence. The prediction information indicates a bi-directional prediction for the current block. The encoding method includes determining two reference blocks of the bi-directional prediction for the current block. In response to both the reference blocks of the bi-directional prediction being across boundaries of reference pictures of the reference blocks, the encoding method includes determining a part of the current block that corresponds to two parts of the two reference blocks each outside the boundary of the reference picture. The encoding method includes encoding the current block by predicting the part of the current block based on one of a uni-prediction and a bi-prediction. The uni-prediction uses samples of a predictor from one of the two reference blocks inside the boundary of one of the reference pictures, and the bi-prediction uses samples of predictors from the two reference blocks inside the boundaries of the reference pictures.

In an embodiment, the encoding method includes determining whether one of the two reference blocks is across a corner of the reference picture of the one of the two reference blocks. In response to one of the two reference blocks being across the corner of the reference picture of the one of the two reference blocks, the encoding method includes encoding the current block by predicting the whole current block based on the bi-prediction using the samples of the predictors from the two reference blocks inside the boundaries of the reference pictures.

In an embodiment, the encoding method includes determining whether the boundaries of the two reference pictures that the two reference blocks are across are at different sides of the two reference pictures. In response to the boundaries of the two reference pictures that the two reference blocks are across being at different sides of the two reference pictures, the encoding method includes encoding the current block by predicting the whole current block based on the bi-prediction using the samples of the predictors from the two reference blocks inside the boundaries of the reference pictures. In response to the boundaries of the two reference pictures that the two reference blocks are across being at the same sides of the two reference pictures, the encoding method includes encoding the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

In an embodiment, in response to two uni-predictions being available for the current block, the encoding method includes encoding the current block by predicting the part of the current block based on a comparison of sizes of two OOB areas each corresponding to one of the two uni-predictions.

In an embodiment, in response to the sizes of the two OOB areas corresponding to the two uni-predictions being the same, the encoding method includes encoding the current block by predicting the part of the current block based on one of the two uni-predictions that is predetermined.

In an embodiment, the encoding method includes determining that at least one of MPDMVR tool or BDOF tool is disallowed for the current block.

In an embodiment, the two reference pictures are the same reference picture.

In an embodiment, the two reference pictures are different reference pictures.

Aspects of the disclosure also provide a non-transitory computer-readable medium storing instructions which when executed by a computer for video decoding cause the computer to perform the method for video decoding.

### BRIEF DESCRIPTION OF THE DRAWINGS

Further features, the nature, and various advantages of the disclosed subject matter will be more apparent from the following detailed description and the accompanying drawings in which:

FIG. 1 shows a block diagram of an encoder according to embodiments of the disclosure;

FIG. 2 shows a block diagram of a decoder according to embodiments of the disclosure;

FIG. 3 is a schematic illustration of a computer system according to embodiments of the disclosure;

FIG. 4 shows exemplary diamond shape search regions for multi-pass decoder-side motion vector refinement (MPDMVR) according to embodiments of the disclosure;

FIG. 5 shows an extended Cu region used in bi-directional optical flow (BDOF) according to embodiments of the disclosure;

FIG. 6 shows an exemplary bi-directional prediction with out-of-boundary (OOB) condition according to embodiments of the disclosure;

FIG. 7 shows another exemplary bi-directional prediction with OOB condition according to embodiments of the disclosure;

FIGS. 8A-8B show exemplary simulation results of the bi-directional prediction with OOB condition according to embodiments of the disclosure;

FIG. 9 shows an exemplary bi-directional prediction with OOB condition when both prediction blocks are in OOB condition according to embodiments of the disclosure;

FIG. 10 shows examples of bi-directional prediction with OOB condition when both prediction blocks are in OOB condition according to embodiments of the disclosure;

FIG. 11A shows an exemplary corner case bi-directional prediction with OOB condition according to embodiments of the disclosure;

FIG. 11B shows examples of bi-prediction with OOB condition according to embodiments of the disclosure;

FIG. 12 shows examples of bi-prediction with OOB condition according to embodiments of the disclosure;

FIG. 13 shows a flowchart illustrating a process of decoding a current block according to embodiments of the disclosure; and

FIG. 14 shows a flowchart illustrating a process of encoding a current block according to embodiments of the disclosure.

### DETAILED DESCRIPTION OF EMBODIMENTS

### I. Video Encoder

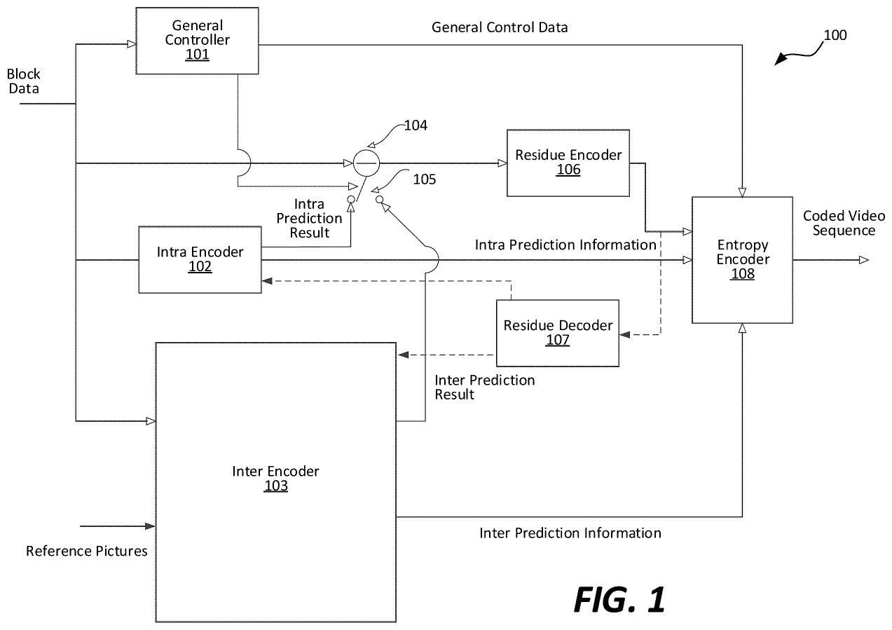

FIG. 1 shows a diagram of a video encoder 100 according to embodiments of the disclosure. The video encoder 100 is configured to receive a processing block (e.g., a prediction block) of sample values within a current video picture in a sequence of video pictures and encode the processing block into an encoded picture that is part of an encoded video sequence.

In an example, the video encoder 100 receives a matrix of sample values for a processing block, such as a prediction block of 8×8 samples, and the like. The video encoder 100 determines whether the processing block is best encoded using intra mode or inter mode using, for example, rate-distortion optimization. When the processing block is to be encoded in intra mode, the video encoder 100 may use an intra prediction technique to encode the processing block into the coded picture; and when the processing block is to be encoded in inter mode such as uni-prediction mode or bi-prediction mode, the video encoder 100 may use an inter uni-prediction or bi-prediction technique, respectively, to encode the processing block into the coded picture. It is noted that merge mode can be a type of the inter mode where the motion vector is derived from one or more motion vector predictors without the benefit of a coded motion vector component outside the predictors. The merge mode can be further classified into, based on a partition type, regular partition merge mode and geometrical partition merge mode. Further, the inter mode can include other modes such as affine mode. In the inter mode, a motion vector component applicable to the subject block may be present. In an example, the video encoder 100 includes other components, such as a mode decision module (not shown) to determine the mode of the processing blocks.

In FIG. 1, the video encoder 100 can include a general controller 101, an intra encoder 102, an inter encoder 103, a residue calculator 104, a switch 105, a residue encoder 106, a residue decoder 107, and an entropy encoder 108.

The general controller 101 is configured to determine general control data and control other components of the video encoder 100 based on the general control data. In an example, the general controller 101 determines the mode of the block and provides a control signal to the switch 105 based on the mode. For example, when the mode is the intra mode, the general controller 101 controls the switch 105 to select the intra mode result for use by the residue calculator 104, and controls the entropy encoder 108 to select the intra prediction information and include the intra prediction information in the bitstream; and when the mode is the inter mode, the general controller 101 controls the switch 105 to select the inter prediction result for use by the residue calculator 104, and controls the entropy encoder 108 to select the inter prediction information and include the inter prediction information in the bitstream.

The intra encoder 102 is configured to receive the samples of the current block (e.g., a processing block), in some cases compare the block to blocks already encoded in the same picture, generate quantized coefficients after transform, and in some cases also intra prediction information (e.g., an intra prediction direction information according to one or more intra encoding techniques). In an example, the intra encoder 102 also calculates intra prediction results (e.g., predicted block) based on the intra prediction information and reference blocks in the same picture.

The inter encoder 103 is configured to receive the samples of the current block (e.g., a processing block), compare the block to one or more reference blocks in reference pictures (e.g., blocks in previous pictures and later pictures), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information.

The residue calculator 104 is configured to calculate a difference (residue data) between the received block and prediction results selected from the intra encoder 102 or the inter encoder 103. The residue encoder 106 is configured to operate based on the residue data to encode the residue data to generate the transform coefficients. In an example, the residue encoder 106 is configured to convert the residue data from a spatial domain to a frequency domain and generate the transform coefficients. The transform coefficients are then subject to quantization processing to obtain quantized transform coefficients. In various embodiments, the video encoder 100 also includes a residue decoder 107. The residue decoder 107 is configured to perform inverse-transform and inverse quantization and generate the decoded residue data. The decoded residue data can be suitably used by the intra encoder 102 and the inter encoder 103. For example, the inter encoder 103 can generate decoded blocks based on the decoded residue data and inter prediction information, and the intra encoder 102 can generate decoded blocks based on the decoded residue data and the intra prediction information. The decoded blocks are suitably processed to generate decoded pictures and the decoded pictures can be buffered in a memory circuit (not shown) and used as reference pictures in some examples.

The entropy encoder 108 is configured to format the bitstream to include the encoded block. The entropy encoder 108 is configured to include various information according to a suitable standard, such as the HEVC standard, VVC or any other video coding standard. In an example, the entropy encoder 108 is configured to include the general control data, the selected prediction information (e.g., intra prediction information or inter prediction information), the residue information, and other suitable information in the bitstream. Note that, according to the disclosed subject matter, when coding a block in the merge sub-mode of either inter mode or bi-prediction mode, there is no residue information.

### II. Video Decoder

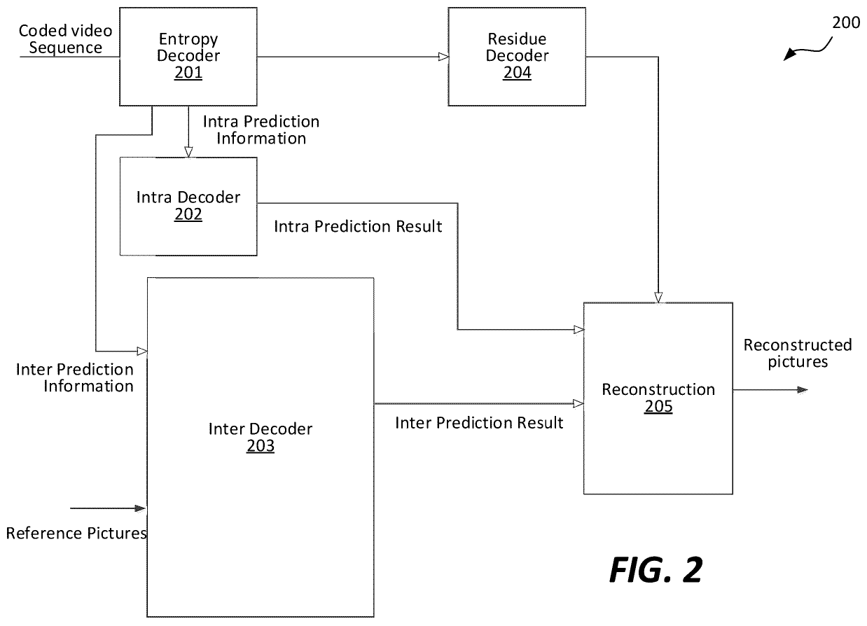

FIG. 2 shows a diagram of a video decoder 200 according to embodiments of the disclosure. The video decoder 200 is configured to receive to-be-decoded pictures that are part of a to-be-decoded video sequence and decode the to-be-decoded pictures to generate reconstructed pictures.

In FIG. 2, the video decoder 200 can include an entropy decoder 201, an intra decoder 202, an inter decoder 203, a residue decoder 204, a reconstruction module 205.

The entropy decoder 201 can be configured to reconstruct, from the encoded picture, certain symbols that represent the syntax elements of which the encoded picture is made up. Such symbols can include, for example, the mode in which a block is encoded (such as, for example, intra mode, inter uni-directional prediction mode, inter bi-predicted mode, the latter two in merge sub-mode or another sub-mode), prediction information (such as, for example, intra prediction information or inter prediction information) that can identify certain sample or metadata that is used for prediction by the intra decoder 202 or the inter decoder 203, respectively, residual information in the form of, for example, quantized transform coefficients, and the like. In an example, when the prediction mode is inter or bi-predicted mode, the inter prediction information is provided to the inter decoder 203; and when the prediction type is the intra prediction type, the intra prediction information is provided to the intra decoder 202. The residual information can be subject to inverse quantization and is provided to the residue decoder 204.

The intra decoder 202 is configured to receive the intra prediction information and generate prediction results based on the intra prediction information.

The inter decoder 203 is configured to receive the inter prediction information and generate inter prediction results based on the inter prediction information.

The residue decoder 204 is configured to perform inverse quantization and inverse transform to extract de-quantized transform coefficients and process the de-quantized transform coefficients to convert the residual from the frequency domain to the spatial domain. The residue decoder 204 may also require certain control information (to include the Quantizer Parameter (QP)), and that information may be provided by the entropy decoder 201 (data path not depicted as this may be low volume control information only).

The reconstruction module 205 is configured to combine, in the spatial domain, the residual as output by the residue decoder 204 and the prediction results (as output by the inter or intra prediction modules as the case may be) to form a reconstructed block, that may be part of the reconstructed picture, which in turn may be part of the reconstructed video. It is noted that other suitable operations, such as a deblocking operation and the like, can be performed to improve the visual quality.

### III. Computer System

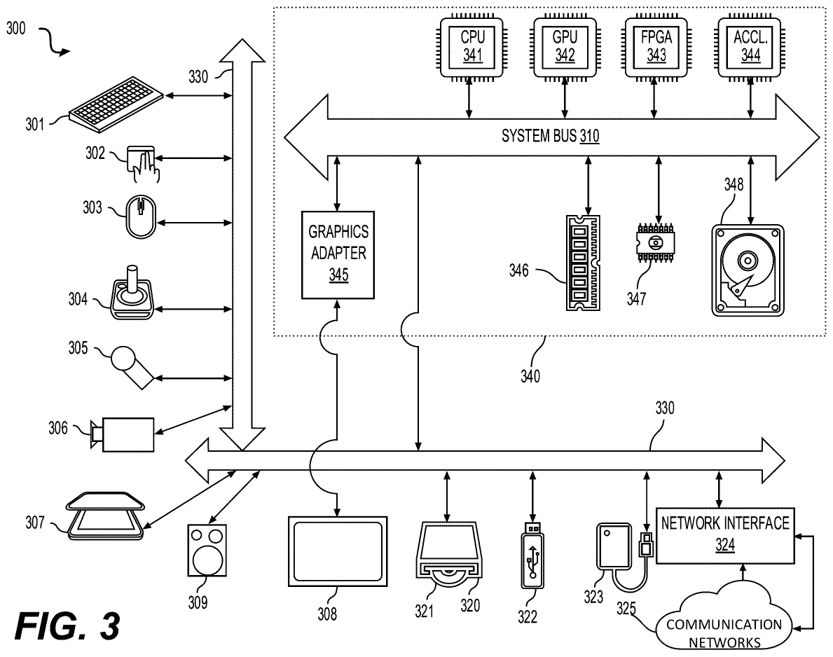

FIG. 3 shows a computer system 300 suitable for implementing embodiments of the disclosed subject matter. The techniques described in this disclosure, can be implemented as computer software using computer-readable instructions and physically stored in one or more computer-readable media. The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 3 for the computer system 300 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of the computer system 300.

The computer system 300 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 301, trackpad 302, mouse 303, joystick 304, microphone 305, camera 306, scanner 307, and touch screen 308.

The computer system 300 may also include certain human interface output devices. Such human interface output devices may be stimulating the senses of one or more human users through, for example, tactile output, sound, light, and smell/taste. Such human interface output devices may include tactile output devices (e.g., tactile feedback by the touch-screen 308 or joystick 304, but there can also be tactile feedback devices that do not serve as input devices), audio output devices (e.g., speaker 309), visual output devices (e.g., screens 308 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted). These visual output devices (such as screens 308) can be connected to a system bus 310 through a graphics adapter 850.

The computer system 300 can also include human accessible storage devices and their associated media such as optical media including CD/DVD ROM/RW 320 with CD/DVD or the like media 321, thumb-drive 322, removable hard drive or solid state drive 323, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

The computer system 300 can also include a network interface 324 to one or more communication networks 325. The one or more communication networks 325 can for example be wireless, wireline, optical. The one or more communication networks 325 can further be local, wide-area, metropolitan, vehicular and industrial, real-time, delay-tolerant, and so on. Examples of the one or more communication networks 325 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses 330 (such as, for example USB ports of the computer system 300; others are commonly integrated into the core of the computer system 300 by attachment to a system bus as described below (for example Ethernet interface into a PC computer system or cellular network interface into a smartphone computer system). Using any of these networks, the computer system 300 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 340 of the computer system 300.

The core 340 can include one or more CPUs 341, one or more GPUs 342, one or more specialized programmable processing units in the form of Field Programmable Gate Areas (FPGA) 343, hardware accelerators for certain tasks 344, graphics adapters 345, and so forth. These devices, along with Random-access memory 346, Read-only memory (ROM) 347, internal mass storage 348 such as internal non-user accessible hard drives, SSDs, and the like, may be connected through the system bus 310. In some computer systems, the system bus 310 can be accessible in the form of one or more physical plugs to enable extensions by additional CPUs, GPU, and the like. The peripheral devices can be attached either directly to the system bus 310, or through a peripheral bus 330. In an example, the screen 308 can be connected to the graphics adapter 345. Architectures for a peripheral bus include PCI, USB, and the like.

CPUs 341, GPUs 342, FPGAs 343, and accelerators 344 can execute certain instructions that, in combination, can make up the aforementioned computer code. That computer code can be stored in ROM 347 or RAM 346. Transitional data can also be stored in RAM 346, whereas permanent data can be stored for example, in the internal mass storage 348. Fast storage and retrieve to any of the memory devices can be enabled through the use of cache memory, that can be closely associated with one or more CPU 341, GPU 342, mass storage 348, ROM 347, RAM 346, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 300 and specifically the core 340 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 340 that are of non-transitory nature, such as core-internal mass storage 348 or ROM 347. The software implementing various embodiments of the present disclosure can be stored in such devices and executed by core 340. A computer-readable medium can include one or more memory devices or chips, according to particular needs. The software can cause the core 340 and specifically the processors therein (including CPU, GPU, FPGA, and the like) to execute particular processes or particular parts of particular processes described herein, including defining data structures stored in RAM 346 and modifying such data structures according to the processes defined by the software. In addition or as an alternative, the computer system can provide functionality as a result of logic hardwired or otherwise embodied in a circuit (for example: accelerator 344), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

### IV. Multi-Pass Decoder-Side Motion Vector Refinement (MPDMVR)

For multi-pass decoder-side motion vector refinement (MPDMVR), in a first pass, bilateral matching (BM) can be applied to a coding block. In a second pass, BM can be applied to each 16×16 sub-block within the coding block. In a third pass, MV in each 8×8 sub-block can be refined by applying bi-directional optical flow (BDOF). The refined MVs can be stored for both spatial and temporal motion vector prediction.

### 1. First Pass—Block Based BM MV Refinement

In the first pass, a refined MV can be derived by applying BM to a coding block. Similar to decoder-side motion vector refinement (DMVR), in bi-prediction operation, a refined MV can be searched around two initial MVs (MV0 and MV1) in the reference picture lists L0 and L1. The refined MVs (MV0_pass1 and MV1_pass1) can be derived around the initiate MVs based on the minimum BM cost between the two reference blocks in L0 and L1.

BM can perform a local search to derive integer sample precision intDeltaMV. The local search can apply a 3×3 square search pattern to loop through a search range [−sHor, sHor] in horizontal direction and [−sVer, sVer] in vertical direction, wherein, the values of sHor and sVer can be determined by a block dimension, and maximum values of sHor and sVer can be 8.

The BM cost can be calculated as: bilCost=mvDistanceCost+sadCost. When the block size cbW×cbH is greater than 64, a mean-removed sum of absolute difference (MRSAD) cost function can be applied to remove the DC effect of distortion between reference blocks. When the bilCost at the center point of the 3×3 search pattern has the minimum cost, the intDeltaMV local search can be terminated. Otherwise, the current minimum cost search point can become a new center point of the 3×3 search pattern and the intDeltaMV local search can continue to search for the minimum cost, until the end of the search range is reached.

The fractional sample refinement can be further applied to derive the final deltaMV. The refined MVs after the first pass can be then derived as MV0_pass1=MV0+deltaMV and MV1_pass1=MV1-deltaMV.

### 2. Second Pass—Sub-Block Based BM MV Refinement

In the second pass, a refined MV can be derived by applying BM to a 16×16 grid sub-block. For each sub-block, a refined MV can be searched around two MVs (MV0_pass1 and MV1_pass1), obtained on the first pass, in the reference picture list L0 and L1. The refined MVs (MV0_pass2(sbIdx2) and MV1_pass2(sbIdx2)) can be derived based on the minimum BM cost between the two reference sub-blocks in L0 and L1.

For each sub-block, BM can perform a full search to derive integer sample precision intDeltaMV. The full search can have a search range [−sHor, sHor] in horizontal direction and [-sVer, sVer] in vertical direction, where the values of sHor and sVer can be determined by a block dimension, and the maximum values of sHor and sVer can be 8.

The BM cost can be calculated by applying a cost factor to the sum of absolute transformed difference (SATD) cost between two reference sub-blocks, as: bilCost=satdCost×costFactor.

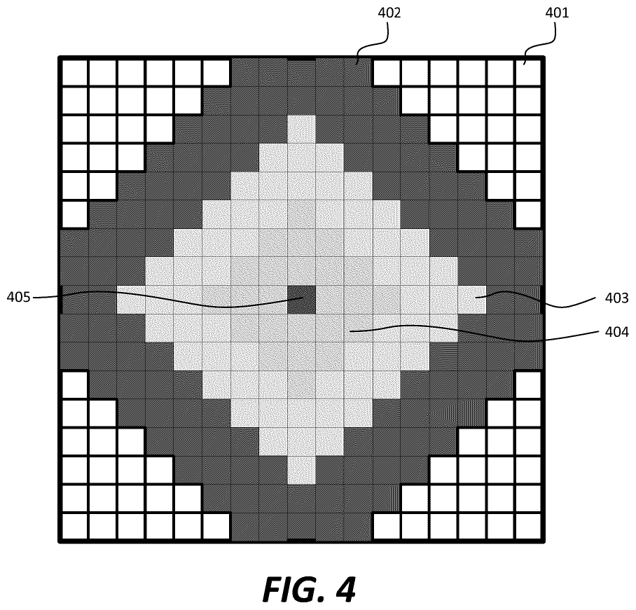

FIG. 4 shows exemplary diamond shape search regions for MPDMVR according to embodiments of the disclosure. The search area (2×sHor+1)×(2×sVer+1) can be divided up to 5 diamond shape search regions 401-405, as shown in FIG. 4. Each search region can be assigned a costFactor, which can be determined by a distance (intDeltaMV) between each search point and the starting MV, and each diamond region can be processed in an order starting from the center of the search area. In each region, the search points can be processed in a raster scan order starting from the top left going to the bottom right corner of the respective region. When the minimum bilCost within the current search region is less than a threshold equal to sbW×sbH, the int-pel full search can be terminated. Otherwise, the int-pel full search can continue to the next search region until all search points are examined. Additionally, if the difference between the previous minimum cost and the current minimum cost in the iteration is less than a threshold that is equal to the area of the block, the search process can terminate.

The VVC DMVR fractional sample refinement can be further applied to derive the final deltaMV (sbIdx2). The refined MVs at the second pass can be then derived as MV0_pass2(sbIdx2)=MV0_pass1+deltaMV (sbIdx2) and MV1_pass2(sbIdx2)=MV1_pass1-deltaMV (sbIdx2).

### 3. Third Pass—Sub-Block Based BDOF MV Refinement

In the third pass, a refined MV can be derived by applying BDOF to an 8×8 grid sub-block. For each 8×8 sub-block, BDOF refinement can be applied to derive scaled Vx and Vy without clipping starting from the refined MV of the parent sub-block of the second pass. The derived bioMv(vₓ,v_{y}) can be rounded to 1/16 sample precision and clipped between −32 and 32. The refined MVs (MV0_pass3(sbIdx3) and MV1_pass3(sbIdx3)) at the third pass can be derived as MV0_pass3(sbIdx3)=MV0_pass2(sbIdx2)+bioMv and MV1_pass3(sbIdx3)=MV0_pass2(sbIdx2)-bioMv.

### V. Bi-Directional Optical Flow (BDOF)

Bi-directional optical flow (BDOF) can be used to refine a bi-prediction signal of a CU at 4×4 sub-block level. BDOF can only be applied to luma component. BDOF can be applied if a CU satisfies all the following conditions: (i) the CU is coded using “true” bi-prediction mode, i.e., one of two reference pictures is prior to the current picture in display order and the other is after the current picture in display order; (ii) distances (i.e., POC difference) from two reference pictures to the current picture are same; (iii) both reference pictures are short-term reference pictures; (iv) the CU is not coded using affine mode or sub-block temporal motion vector prediction (SbTMVP) merge mode; (v) the CU has more than 64 luma samples; (vi) both CU height and CU width are larger than or equal to 8 luma samples; (vii) a weight index of bi-prediction with CU-level weight (BCW) indicates equal weight; (viii) weighted prediction (WP) is not enabled for the CU; and (ix) combined inter-intra prediction (CIIP) mode is not used for the CU.

The BDOF mode is based on the concept of optical flow, which has multiple assumptions: a brightness constancy assumption (value of a pixel is not changed by the displacement), a gradient constancy assumption (gradient of the image assumed not to vary due to the displacement), and a discontinuity-preserving spatio-temporal smoothness constraint (piecewise smoothness of the flow field).

For each 4×4 sub-block, a motion refinement (vₓ,v_{y}) can be calculated by minimizing the difference between the L0 and L1 prediction samples. The motion refinement can then be used to adjust the bi-predicted sample values in the 4×4 sub-block. The following steps can be applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0, 1, of the two prediction signals can be computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) )$$

$$\frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )$$

where I^{(k)}(i,j) are the sample value at coordinate (i,j) of the prediction signal in list k, k=0, 1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , {S}_{3} = {\sum }_{( i , j ) ∈ Ω} θ ( i , j ) \cdot Sign ( {ψ}_{x} ( i , j ) )$$

$${S}_{2} = {\sum }_{( i , j ) ∈ Ω} {ψ}_{x} ( i , j ) \cdot Sign ( {ψ}_{y} ( i , j ) )$$

$${S}_{5} = {\sum }_{( i , j ) ∈ Ω} Abs ( {ψ}_{y} ( i , j ) ) , {S}_{6} = {\sum }_{( i , i ) ∈ Ω} θ ( i , j ) \cdot Sign ( {ψ}_{y} ( i , j ) )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a}$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a}$$

$$θ ( i , j ) = ( {I}^{( 1 )} ( i , j ) ≫ {n}_{b} ) - ( {I}^{( 0 )} ( i , j ) ≫ {n}_{b} )$$

where Ω is a 6×6 window around the 4×4 sub-block, and the values of nₐ and n_{b} are set equal to min(1, bitDepth−11) and min(4, bitDepth−8), respectively.

The motion refinement (vₓ,v_{y}) is then derived using the cross- and auto-correlation terms using the following:

$${v}_{x} = {S}_{1} > 0 > clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) : 0$$

where S_{2,m}=S₂>>n_{S}_{₂}, S_{2,s}=S₂&(2ⁿ^{_{S2}}−1),

$$t {h}_{BIO}^{′} = {2}^{max ( 5 , BD - 7 )} .$$

└⋅┘ is the floor function, and n_{S}_{₂}=12.

Based on the motion refinement and the gradients, the following adjustment is calculated for each sample in the 4×4 sub-block:

$$b ( x , y ) = rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU can be calculated by adjusting the bi-prediction samples as follows:

pred_{BDOF}(x,y)=(I⁽⁰⁾(x,y)+I⁽¹⁾(x,y)+b(x,y)+o_{offset})>>shift

These values are selected such that the multipliers in the BDOF process do not exceed 15-bit, and the maximum bit-width of the intermediate parameters in the BDOF process is kept within 32-bit.

In order to derive the gradient values, some prediction samples I^{(k)}(i,j) in list k (k=0, 1) outside of the current CU boundaries need to be generated.

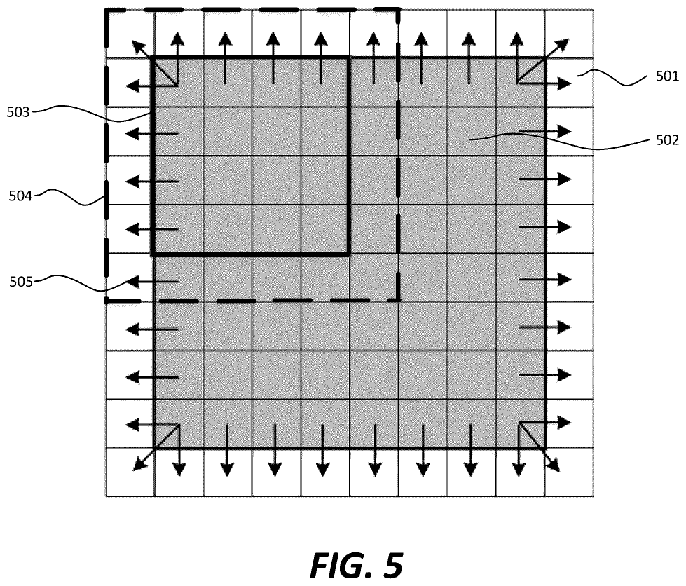

FIG. 5 shows an extended CU region used in BDOF according to embodiments of the disclosure. As shown in FIG. 5, the BDOF in VVC can use one extended row/column around boundaries of a CU. In order to control the computational complexity of generating the out-of-boundary prediction samples, prediction samples in the extended area (white-colored area such as area 501) can be generated by taking the reference samples at the nearby integer positions (using floor( ) operation on the coordinates) directly without interpolation, and a normal 8-tap motion compensation (MC) interpolation filter can be used to generate prediction samples within the CU (gray-colored area such as area 502). These extended sample values can be used in gradient calculation only. For the remaining steps in the BDOF process, if any sample and gradient values outside of the CU boundaries are needed, they can be padded (or repeated) from their nearest neighbors. For example, in FIG. 5, for a 4×4 sub-block 503, a 6×6 surrounding region 504 is an extended region for the BDOF process, and the samples and gradients such as 505 can be padded.

When a width and/or a height of a CU are larger than 16 luma samples, the CU can be split into sub-blocks with the width and/or the height equal to 16 luma samples, and the sub-block boundaries can be treated as the CU boundaries in the BDOF process. The maximum unit size for the BDOF process can be limited to 16×16. For each sub-block, the BDOF process can be skipped. When the sum of absolute difference (SAD) between the initial L0 and L1 prediction samples is smaller than a threshold, the BDOF process is not applied to the sub-block. The threshold can be set equal to 8×W×(H>>1), where W indicates the sub-block width, and H indicates sub-block height. To avoid additional complexity of the SAD calculation, the SAD between the initial L0 and L1 prediction samples calculated in DVMR process can be re-used here.

If BCW is enabled for a current block, i.e., the BCW weight index indicates unequal weight, then the BDOF process can be disabled for the current block. Similarly, if WP is enabled for the current block, i.e., the luma_weight_lx_flag is 1 (or true) for either of the two reference pictures, then the BDOF process can be disabled. When a CU is coded with symmetric MVD mode or CIIP mode, the BDOF process can be disabled.

VI. Bi-Directional Prediction with Out-of-Boundary (OOB)

In enhanced compression model ECM-4.0, due to the reference samples padding of the reference picture, it is possible for an inter CU to have a reference block partially or totally located outside a boundary of a reference picture corresponding to the reference block. Such a case can be referred to an out-of-boundary (OOB) condition for the inter CU.

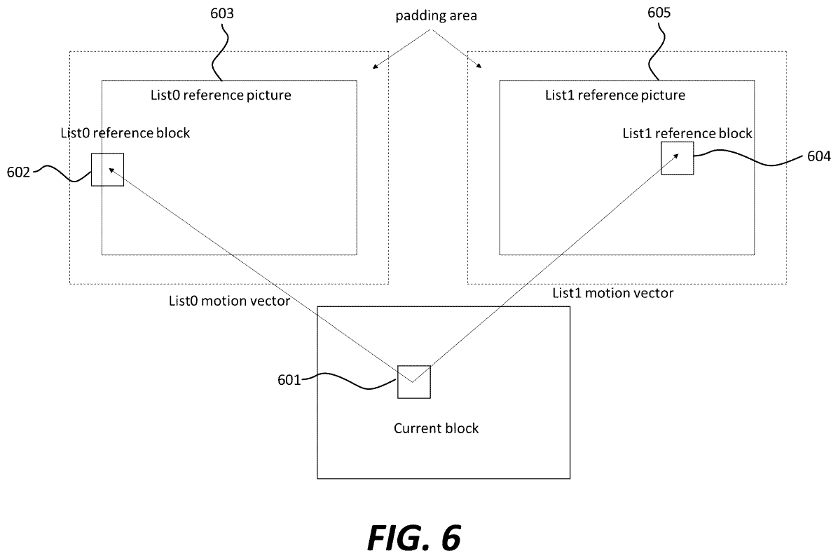

FIG. 6 shows an exemplary bi-directional prediction with OOB condition according to embodiments of the disclosure. In FIG. 6, the bi-directional MC can be performed to generate an inter prediction block of a current block 601. L0 reference block 602 is partially OOB of L0 reference picture 603 while L1 reference block 604 is fully inside L1 reference picture 605. However, the OOB part of the motion compensated block usually provides less prediction efficiency because reference samples of the OOB part are simply repetitive samples derived from the boundary samples within the reference picture. This repetition can be referred to a padding process.

Since the OOB reference samples are generated through the padding process, the MC predictors generated using the OOB reference samples are less effective. In related arts such as JVET-Y0125, when combining more than one prediction blocks generated by the MC process, the OOB predictors can be discarded and only the non-OOB predictors can be used to generate the final predictor.

To be specific, positions of the predictors within a current block can be denoted as Pos_x_{i,j} and Pos_y_{i,j}, the MV of the current block can be denoted as

$${Mv\_x}_{i , j}^{L x} and {Mv\_y}_{i , j}^{L x}$$

(x can be 0 or 1 for L0 or L1, respectively). POS_{LeftBdry}, POS_{RightBdry}, POS_{TopBdry}, and Pos_{BottomBdry} are positions of four boundaries of a picture. Since 1/16-pel MV is used in the ECM, all variables can be denoted in a unit of the 1/16 sample and thus a value of half pixel is set equal to 8.

The predictor

$${P}_{i , j}^{L x}$$

is regarded as OOB when at least one of the following conditions holds: (i)

$$( {Pos\_x}_{i , j} + {Mv\_x}_{i , j}^{Lx} ) > ( {Pos}_{RightBdry} + half\_pixel ) ;$$

$$( {Pos\_x}_{i , j} + {Mv\_x}_{i , j}^{Lx} ) < ( {Pos}_{LeftBdry} - half\_pixel ) ; \qquad ( ii )$$

$$( {Pos\_y}_{i , j} + {Mv\_y}_{i , j}^{Lx} ) > ( {Pos}_{Bottomdry} + half\_pixel ) ; or \qquad ( iii )$$

$$( {Pos\_y}_{i , j} + {Mv\_y}_{i , j}^{Lx} ) > ( {Pos}_{TopBdry} - half\_pixel ) . \qquad ( iv )$$

Otherwise, when none of the above conditions holds, the predictor

$${P}_{i , j}^{L x}$$

can be regarded as non-JOB.

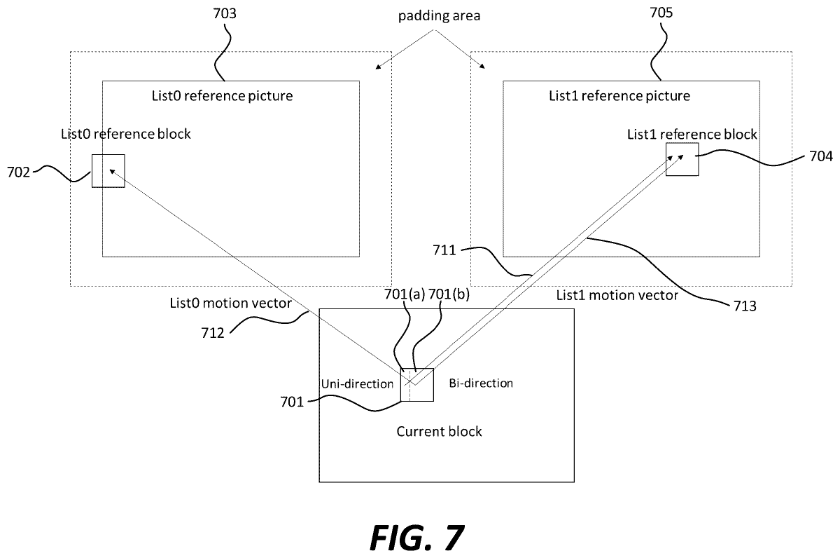

FIG. 7 shows another exemplary bi-directional prediction with OOB condition according to embodiments of the disclosure. After the OOB condition is determined for each predictor, the following procedure can be applied to the bi-directional MC block to generate the final predictor: if

$${P}_{i , j}^{L 0}$$

### is OOB and

$${P}_{i , j}^{L 1}$$

is non-OOB, is non-OOB and

$${P}_{i , j}^{f i n a l} = {P}_{i , j}^{L 1} ; else if {P}_{i , j}^{L 0}$$

is non-OOB and

$${P}_{i , j}^{L 1} is OOB , {P}_{i , j}^{final} = {P}_{i , j}^{L 0} ; else {P}_{i , j}^{f i n a l} = ( {P}_{i , j}^{L 0} + {P}_{i , j}^{L 1} + 1 ) >> 1.$$

In the following paragraphs, this procedure can be referred to as OOB calibration. As shown in FIG. 7, a current block 701 can include a left part 701(a) and a right part 701(b). For the left part 701(a), a corresponding part of L0 reference block 702 is OOB of L0 reference picture 703, and thus a final predictor of the left part 701(a) can be from the corresponding part of L1 reference block 704, as shown by the MV 711. For the right part 701(b), each corresponding part of L0 reference block 702 and L1 reference block 704 is inside the respective reference picture, and thus a final predictor of the right part 701(b) can be from both the corresponding parts of L0 reference block 702 and L1 reference block 704, as shown by the MVs 712 and 713.

It is noted that the same checking mechanism can be applied when BCW is enabled.

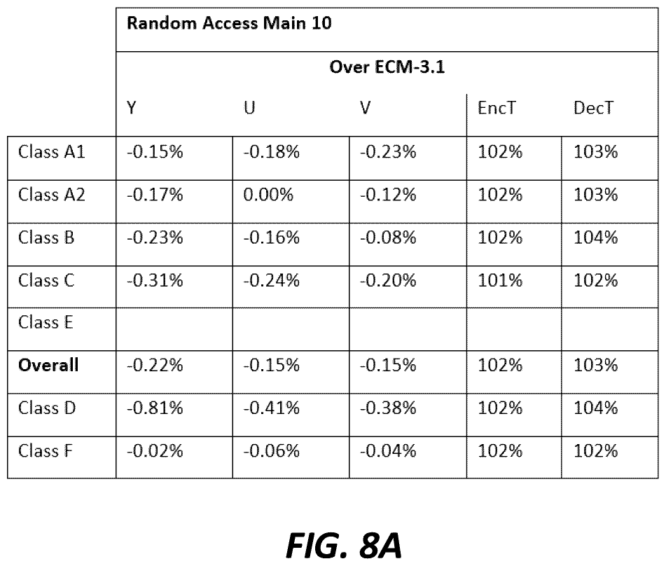

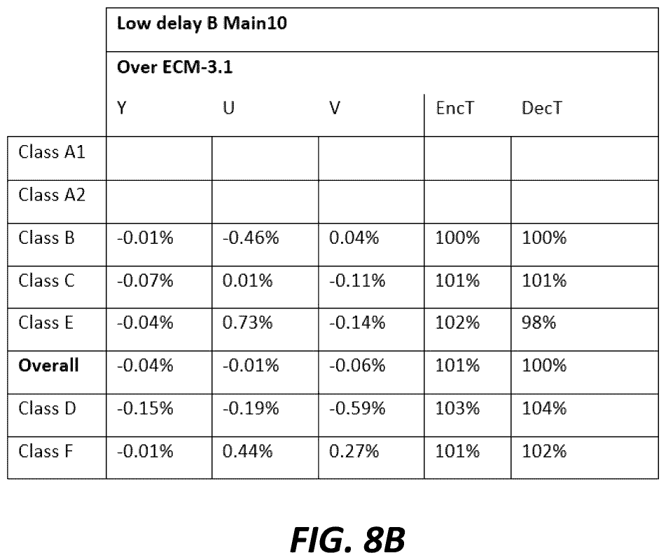

FIGS. 8A-8B show exemplary simulation results of the bi-directional prediction with OOB condition according to embodiments of the disclosure. The procedure in FIG. 7 was implemented on top of the reference software ECM-3.1 and tested using the common test conditions. It is noted that single instruction/multiple data (SIMD) is not used in the implementation, but the run time can be further optimized after SIMD implementation is applied to the procedure.

In an embodiment, an OOB checking procedure can fill sample-based luma OOB map and chroma OOB map, and check OOB definition: (i) offset sample is located outside the reference picture beyond half sample; and (ii) ((pos.x*16+mv.hor)<=−8)∥((pos.x*16+mv.hor)>=(pic.width−1)*16+8)( 1/16 precision). The OOB checking procedure can check OOB per list (L0 and L1) and per luma sample for bi-directional prediction mode. Chroma OOB map can be sub-sampled from luma OOB map, even for affine mode, where the chroma MV is averaged from 2 luma MVs. The OOB checking procedure can check 4 corners of the current block first to conditionally skip sample-based OOB check. If 4 corners are not OOB, all OOB maps can be set to 0 and the sample-based OOB check can be skipped. For sub-block modes (such as MP-DMVR (pass3) or affine mode), the OOB checking procedure can check OOB per sub-block. OOB is not applied to the templates of adaptive reordering of merge candidates with template matching (ARMC-TM). The OOB checking procedure can perform SIMD for OOB check (but no SIMD for OOB averaging prediction).

VII. Improvements on Bi-Directional Prediction with OOB Condition

In related arts such as JVET-Y0125, the OOB condition is checked for each sample position in the bi-predicted coding block (CB). There may be cases when both predictors are outside-of-boundary of reference pictures.

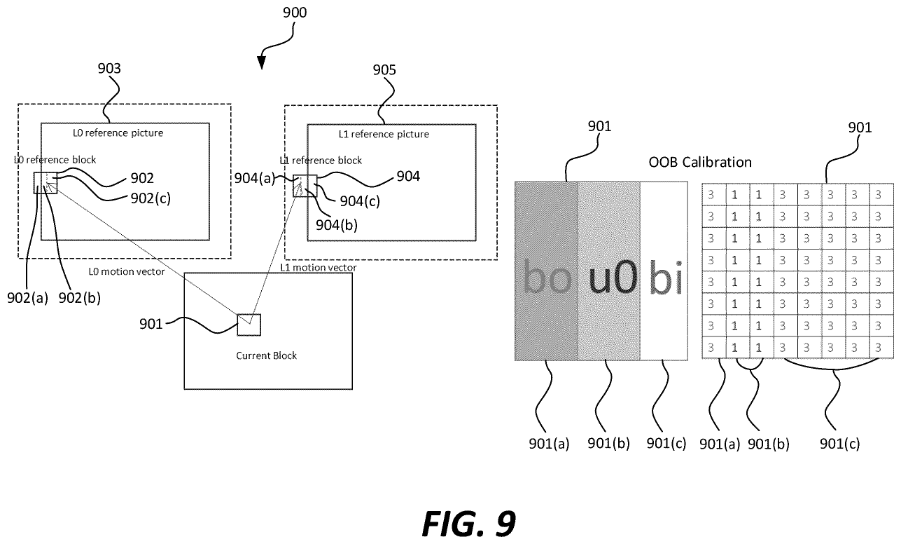

FIG. 9 shows an exemplary bi-directional prediction with OOB condition according to embodiments of the disclosure. As shown in the bi-directional prediction 900, both L0 and L1 reference blocks 902 and 904 of a current block 901 are partially OOB of L0 and L1 reference pictures 903 and 905, respectively. The current block 901 can include or be partitioned into three parts 901(a)-901(c). A first part (i.e., left part) 901(a) of the current block 901 corresponds to an OOB part 902(a) of L0 reference block 902 and an OOB part 904(a) of L1 reference block 904, and thus a final prediction of the left part 901(a) can be constructed by a bi-prediction using padded samples (as indicated as bo or 3) from L0 and L1 reference blocks 902 and 904. A second part (i.e., middle part) 901(b) of the current block 901 corresponds to a non-OOB part 902(b) of L0 reference block 902 and an OOB part 904(b) of L1 reference block 904, and thus a final prediction of the middle part 901(b) can be constructed by a uni-prediction using samples (as indicated as u0 or 1) of a predictor from L0 reference block 902. A third part (i.e., right part) 901(c) of the current block 901 corresponds to a non-OOB part 902(c) of L0 reference block 902 and a non-OOB part 904(c) of L1 reference block 904, and thus a final prediction of the right part 901(c) can be constructed by a bi-prediction using samples (as indicated as bi or 3) of predictors from L0 reference block 902 and L1 reference block 904 inside boundaries of the L0 and L1 reference picture 903 and 905.

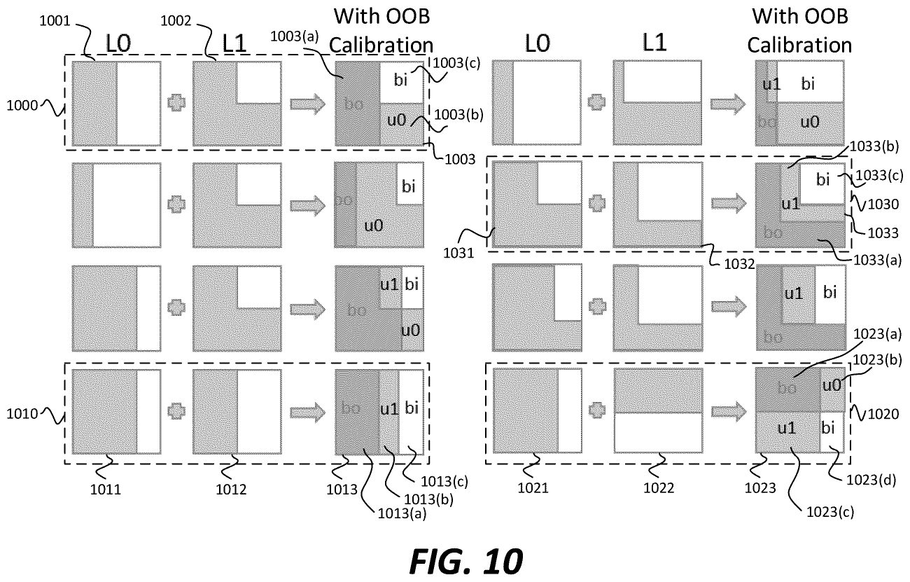

FIG. 10 shows examples of bi-directional prediction with OOB condition when both prediction blocks are in OOB condition according to embodiments of the disclosure. In the examples shown in FIG. 10, OOB parts are indicated as light and dark gray colored area, and non-OOB parts are indicated as white colored area. For a part of a current block corresponding to both OOB parts in L0 and L1 reference blocks, a final prediction of the part of the current block can be constructed by a bi-prediction bo using padded samples from L0 and L1. For a part corresponding to only one OOB part in either L0 or L1 reference block, a final prediction can be constructed by a uni-prediction u0 or u1 using samples of a predictor from either L0 or L1. For a part corresponding to both non-OOB parts in L0 and L1 reference blocks, a final prediction can be constructed by a bi-prediction bi using samples of predictors from both L0 and L1 reference blocks inside the L0 and L1 reference picture boundaries.

In a bi-prediction 1000 in FIG. 10, L0 reference block 1001 is across a left boundary of L0 reference picture, and L1 reference block 1002 is across a left-bottom corner of L1 reference picture. Accordingly, a final prediction of a current block 1003 can include a first prediction 1003(a) constructed by a bi-prediction bo using padded samples from L0 and L1 reference blocks 1001 and 1002, a second prediction 1003(b) constructed by a uni-prediction u0 using samples of a predictor from L0 reference block 1001, and a third prediction 1003(c) constructed by a bi-prediction bi using samples of predictors from both L0 and L1 reference blocks 1001 and 1002 inside the L0 and L1 reference picture boundaries.

In a bi-prediction 1010 in FIG. 10, both L0 and L1 reference blocks 1011 and 1012 are across left boundaries of L0 and L1 reference pictures, respectively. Accordingly, a final prediction of a current block 1013 can include a first prediction 1013(a) constructed by a bi-prediction bo using padded samples from L0 and L1 reference blocks 1011 and 1012, a second prediction 1013(b) constructed by a uni-prediction u1 using samples of a predictor from L1 reference block 1012, and a third prediction 1003(c) constructed by a bi-prediction bi using samples of predictors from both L0 and L1 reference blocks 1011 and 1012 inside the L0 and L1 reference picture boundaries.

In a bi-prediction 1020 in FIG. 10, L0 reference block 1021 is across a left boundary of L0 reference picture, and L1 reference block 1022 is across a top boundary of L1 reference picture. Accordingly, a final prediction of a current block 1023 can include a first prediction 1023(a) constructed by a bi-prediction bo using padded samples from L0 and L1 reference blocks 1021 and 1022, a second prediction 1023(b) constructed by a uni-prediction u0 using samples of a predictor from L0 reference block 1021, a third prediction 1023(c) constructed by a uni-prediction u1 using samples of a predictor from L1 reference block 1022, and a fourth prediction 1023(d) constructed by a bi-prediction bi using samples of predictors from both L0 and L1 reference blocks 1021 and 1022 inside the L0 and L1 reference picture boundaries.

In a bi-prediction 1030 in FIG. 10, both L0 and L1 reference blocks 1031 and 1032 are across picture corners of L0 and L1 reference pictures, respectively. Accordingly, a final prediction of a current block 1033 can include a first prediction 1033(a) constructed by a bi-prediction bo using padded samples from L0 and L1 reference blocks 1031 and 1032, a second prediction 1033(b) constructed by a uni-prediction u1 using samples of a predictor from L1 reference block 1032, and a third prediction 1033(c) constructed by a bi-prediction bi using samples of predictors from both L0 and L1 reference blocks 1031 and 1032 inside the L0 and L1 reference picture boundaries.

It is noted that a bi-prediction can be referred to as a corner case bi-prediction if at least one reference block in the bi-prediction is across a corner of a corresponding reference picture. That is, in a corner case bi-prediction, at least one reference block of a current block is across two boundaries of a corresponding reference picture. In FIG. 10, the bi-prediction 1000 is a corner case bi-prediction. In a non-corner case bi-prediction, no reference block is across a corner of a corresponding reference picture. That is, in a non-corner case bi-prediction, each reference block is across only one boundary of a corresponding reference picture. In FIG. 10, the bi-predictions 1010 and 1020 are non-corner case bi-predictions. A difference between the bi-predictions 1010 and 1020 is that both reference blocks 1011 and 1012 in the bi-prediction 1010 are across the same boundary (i.e., left boundary) of the corresponding reference pictures while two reference blocks 1021 and 1022 in the bi-prediction 1020 are across different boundaries (i.e., reference block 1021 is across the left boundary and reference block 1022 is across the top boundary) of the corresponding reference pictures.

In the related arts, an issue of the OOB calibration is that a decision is made for every sample position of a current block, resulting in a complicated combination of a bi-prediction using padded samples, a uni-prediction using samples from either L0 reference or L1 reference picture, and a bi-prediction using samples from both L0 and L1 reference pictures inside the boundaries. This disclosure provides embodiments of improving the OOB calibration or checking procedure for a bi-prediction with OOB.

In one embodiment, the OOB calibration of a bi-prediction can be skipped if at least one condition is true: (i) the bi-prediction is a corner case bi-prediction (e.g., the bi-prediction 1000 in FIG. 10); or (ii) two predictors of the bi-prediction are at different boundaries of the corresponding reference pictures (e.g., the bi-prediction 1030 in FIG. 10). Otherwise, after the OOB condition of each predictor is scanned, available prediction direction(s) (u0, u1, or bi) can be obtained, and the bi-prediction bo using padded samples can be changed to the available uni-prediction u0 or u1. In an example, if both uni-predictions u0 and u1 are available, one (e.g., u0) of them can be used by default.

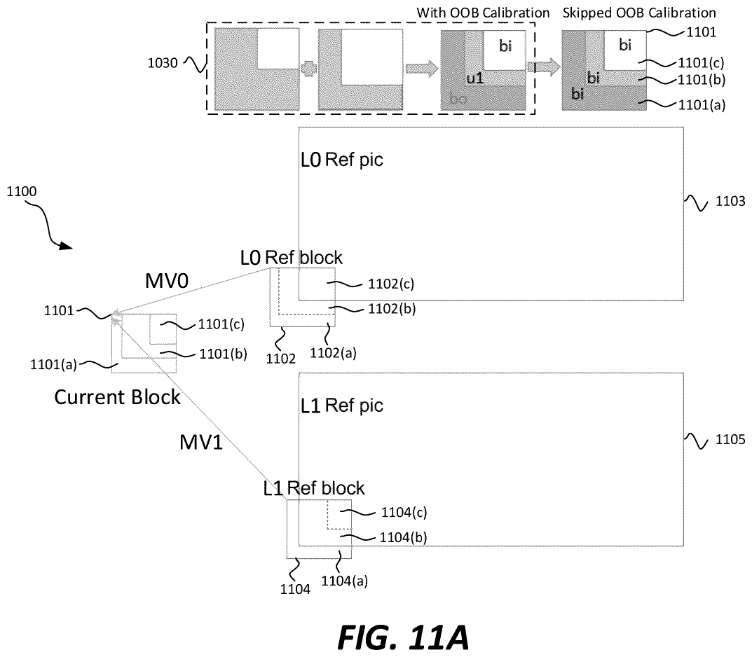

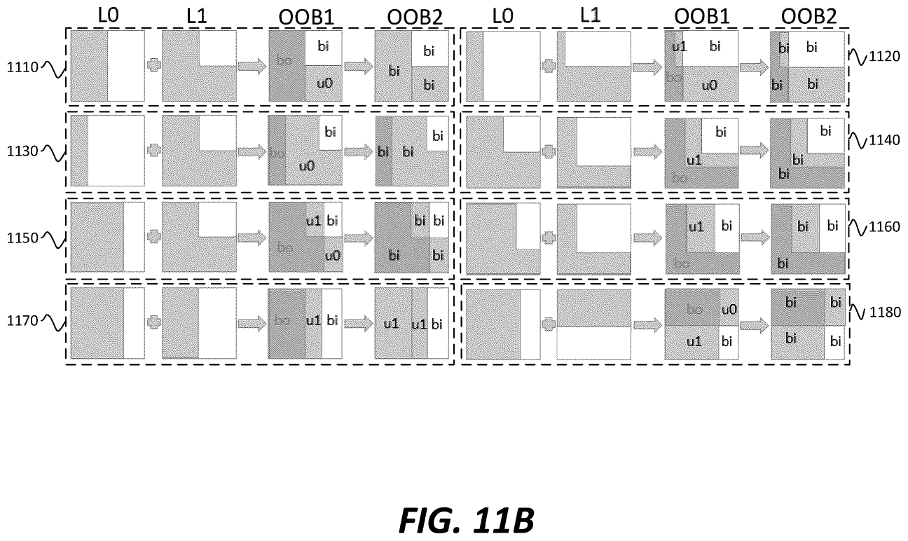

FIG. 11A shows a corner case bi-directional prediction 1100 according to embodiments of the disclosure. Similar to the bi-prediction 1030, in the corner case bi-directional prediction 1100, both L0 and L1 reference blocks 1102 and 1104 of a current block 1101 are partially OOB and across picture corners of L0 and L1 reference pictures 1103 and 1105, respectively. The current block 1101 can include three parts 1101(a)-1101(c). A first part 1101(a) of the current block 1101 corresponds to an OOB part 1102(a) of L0 reference block 1102 and an OOB part 1104(a) of L1 reference block 1104. Thus, a final prediction of the first part 1101(a), which is constructed by a bi-prediction bo in the bi-prediction 1030, can be constructed by a bi-prediction bi using samples of predictors from both L0 and L1 reference blocks 1102 and 1104 inside the L0 and L1 reference picture boundaries in the corner case bi-directional prediction 1100. A second part 1101(b) of the current block 1101 corresponds to an OOB part 1102(b) of L0 reference block 1102 and a non-OOB part 1104(b) of L1 reference block 1104. Thus, a final prediction of the second part 1101(b), which is constructed by a uni-prediction u1 in the bi-prediction 1030, can be constructed by the bi-prediction bi in the corner case bi-directional prediction 1100. A third part 1101(c) of the current block 1101 corresponds to a non-OOB part 1102(c) of L0 reference block 1102 and a non-OOB part 1104(c) of L1 reference block 1104. Thus, a final prediction of the third part 1101(c) can be constructed by the bi-prediction bi in the corner case bi-directional prediction 1100. That is, because of the corner case bi-prediction 1100, the OOB calibration can be skipped for the current block 1101, and the bi-prediction bi can be applied to the whole block 1101.

FIG. 11B shows examples of bi-prediction with OOB condition according to embodiments of the disclosure. In FIG. 11B, columns L0 and L1 represent L0 and L1 reference blocks, and columns OOB1 and OOB2 represent two types of bi-predictions. For OOB1, the bi-prediction method illustrated in FIG. 9 is used, and thus each of bi-prediction 1110-1180 corresponds to one respective bi-prediction in FIG. 10. For OOB2, the OOB calibration is skipped for a corner case bi-prediction or a bi-prediction with two predictors at different boundaries, and the bi-prediction bo is replaced by a uni-prediction for a non-corner case bi-prediction. Specifically, bi-predictions 1110-1160 are corner case bi-predictions, and two predictors of bi-prediction 1180 are at different boundaries. Accordingly, in OOB1, the OOB calibration can be performed for each of the bi-predictions 1110-1160 and 1180, and a final prediction of each current block can be a combination of bi-prediction bo, uni-prediction u0 and/or u1, and bi-prediction bi. In OOB2, the OOB calibration can be skipped for the bi-predictions 1110-1160 and 1180. That is, in the bi-predictions 1110-1160 and 1180, the uni-predictions u0 and/or u1 and/or bi-prediction bo using padded samples can be replaced by a bi-prediction bi using samples of predictors from both L0 and L1 reference blocks inside L0 and L1 reference picture boundaries. For example, similar to the corner case bi-directional prediction 1100, in the corner case bi-prediction 1140, both L0 and L1 reference blocks of a current block are partially OOB and across picture corners of L0 and L1 reference pictures, respectively. Accordingly, the OOB calibration can be skipped and the whole current block can be constructed using the bi-prediction bi.

In FIG. 11B, bi-prediction 1170 is not a corner case bi-prediction, and two predictors of the bi-prediction 1170 are at the same boundary. Thus, the OOB calibration can be performed for the bi-prediction 1170. In OOB1, since both predictors are OOB, the prediction result can include three parts: a bi-prediction bo using padded samples from both L0 and L1 reference pictures, a uni-dictional prediction u1 using samples from L1 reference picture, and a bi-prediction bi using samples of predictors from both L0 and L1 reference blocks inside L0 and L1 reference picture boundaries. This is not only increasing a complexity of the prediction but also can reduce the prediction accuracy, since in the bi-prediction bo prediction samples of both prediction blocks are outside of the picture boundaries and generated by a padding process. Instead, in OOB2, the bi-prediction bo is replaced by the available uni-prediction u1, resulting in a more accurate prediction, since less padded samples are used for prediction. The uni-prediction u1 is available and thus samples from L1 reference block can be used for predicting a part of a current block corresponding to the bi-prediction bo.

In one embodiment, a bi-prediction bo can be replaced by an available uni-prediction u0 or u1. If both uni-predictions u0 and u1 are available, one of the uni-predictions can be used by default to replace the bi-prediction bo. In an example, the uni-prediction u0 can be used by default. In an example, the uni-prediction u1 can be used by default.

In one embodiment, a bi-prediction bo can be replaced by an available uni-prediction u0 or u1. If both uni-predictions u0 and u1 are available and areas from u0 and u1 are the same, one of the uni-predictions can be used by default to replace the bi-prediction bo. In an example, the uni-prediction u0 can be used by default. In an example, the uni-prediction u1 can be used by default.

In one embodiment, a bi-prediction bo can be replaced by an available uni-prediction u0 or u1. If both uni-prediction u0 and u1 are available and areas from u0 and u1 are different, one of the uni-predictions with a larger area can be used to replace the bi-prediction bo.

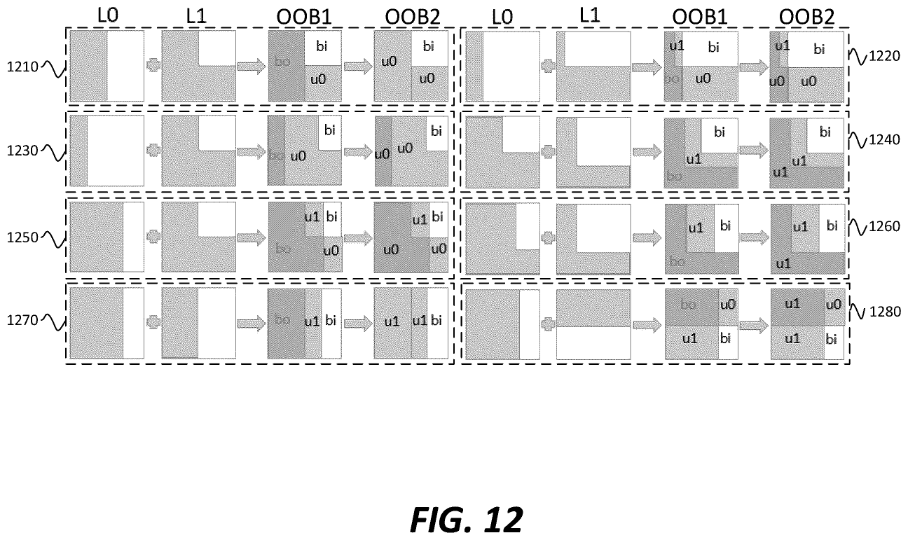

FIG. 12 shows examples of bi-prediction with OOB condition according to embodiments of the disclosure. In FIG. 12, columns L0 and L1 represent L0 and L1 reference blocks, and columns OOB1 and OOB2 represent two types of bi-predictions. For OOB1, the bi-prediction method illustrated in FIG. 9 is used, and thus each of bi-prediction 1210-1280 corresponds to one respective bi-prediction in FIG. 10. For OOB2, in the OOB calibration, a bi-prediction bo can be replaced by an available uni-prediction u0 or u1. Specifically, for bi-predictions 1210, 1230, 1240, 1260, and 1270, since only one uni-prediction is available, the bi-prediction bo is replaced by the only available uni-prediction. In an example, in bi-prediction 1210, the bi-prediction bo is replaced by the only available uni-prediction u0. In an example, in bi-prediction 1240, the bi-prediction bo is replaced by the only available uni-prediction u1. For bi-predictions 1220, 1250, and 1280, since both uni-predictions u0 and u1 are available, a size (or area) comparison between OOB areas corresponding to the uni-predictions u0 and u1 can be performed to determine one of the uni-predictions u0 and u1 to be used to replace the bi-prediction bo. In an example, for the bi-prediction 1220, the OOB area corresponding to the uni-prediction u0 is greater than the OOB area corresponding to the uni-prediction u1, and thus the uni-prediction u0 is used to replace the bi-prediction bo. In an example, for the bi-prediction 1250, the OOB area corresponding to the uni-prediction u0 is the same as the OOB area corresponding to the uni-prediction u1, and thus the uni-prediction u0 is used by default to replace the bi-prediction bo. In an example, for the bi-prediction 1280, the OOB area corresponding to the uni-prediction u0 is less than the OOB area corresponding to the uni-prediction u1, and thus the uni-prediction u1 is used to replace the bi-prediction bo.

In one embodiment, only one reference block is allowed as an OOB block. The OOB calibration can be skipped for a whole block if both reference blocks are located partially outside the corresponding reference pictures. Under this constraint, all corner case bi-predictions can be disallowed.

In one embodiment, whether to perform the OOB calibration can be determined and applied to the whole block (all three color components) at once.

In one embodiment, MPDMVR and/or BDOF tools can be skipped or disallowed for MVs corresponding to L0 and L1 predictors which are both outside of the corresponding reference pictures, while conditions and/or rules for OOB applications are not changed.

### VIII. Decoding Flowchart

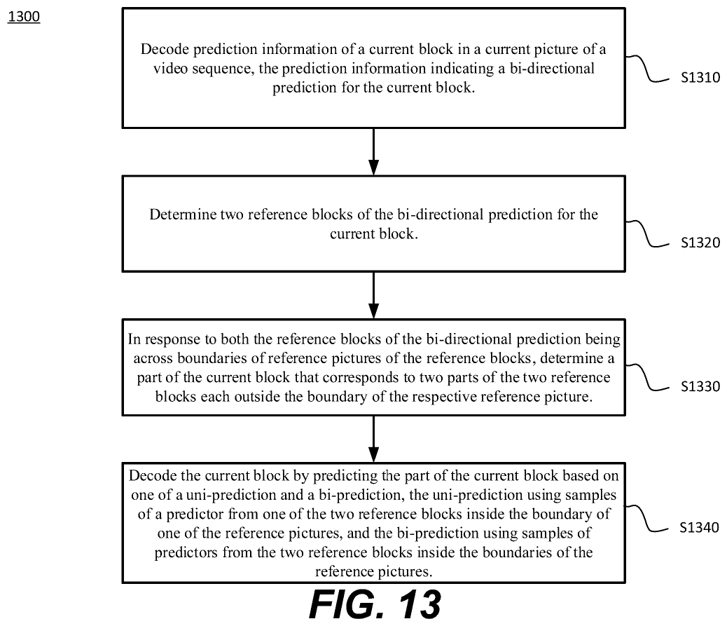

FIG. 13 shows a flow chart outlining a decoding process 1300 according to embodiments of the disclosure. The decoding process 1300 can be used in decoding a to-be-decoded block using a bi-prediction with OOB. In various embodiments, the decoding process 1300 can be executed by processing circuitry, such as CPU 341 and/or GPU 342 of the computer system 300. In some embodiments, the decoding process 1300 is implemented in software instructions, thus when the processing circuitry executes the software instructions, the processing circuitry performs the decoding process 1300. The decoding process can start at S1310.

At step S1310, the decoding process 1300 decodes prediction information of a current block in a current picture of a video sequence. The prediction information indicates a bi-directional prediction for the current block. Then, the decoding process 1300 proceeds to step S1320.

At step S1320, the decoding process 1300 determines two reference blocks of the bi-directional prediction for the current block. Then, the decoding process 1300 proceeds to step S1330.

At step S1330, in response to both the reference blocks of the bi-directional prediction being across boundaries of reference pictures of the reference blocks, the decoding process 1300 determines a part of the current block that corresponds to two parts of the two reference blocks each outside the boundary of the respective reference picture. Then, the decoding process 1300 proceeds to step S1340.

At step S1340, the decoding process 1300 decodes the current block by predicting the part of the current block based on one of a uni-prediction and a bi-prediction. The uni-prediction uses samples of a predictor from one of the two reference blocks inside the boundary of one of the reference pictures, and the bi-prediction uses samples of predictors from the two reference blocks inside the boundaries of the reference pictures.

Then, the decoding process 1300 terminates.

In an embodiment, the decoding process 1300 determines whether one of the two reference blocks is across a corner of the reference picture of the one of the two reference blocks. In response to one of the two reference blocks being across the corner of the reference picture of the one of the two reference blocks, the decoding process 1300 decodes the current block by predicting the whole current block based on the bi-prediction using the samples of the predictors from the two reference blocks inside the boundaries of the reference pictures.

In an embodiment, the decoding process 1300 determines whether the boundaries of the two reference pictures that the two reference blocks are across are at different sides of the two reference pictures. In response to the boundaries of the two reference pictures that the two reference blocks are across being at different sides of the two reference pictures, the decoding process 1300 decodes the current block by predicting the whole current block based on the bi-prediction using the samples of the predictors from the two reference blocks inside the boundaries of the reference pictures. In response to the boundaries of the two reference pictures that the two reference blocks are across being at the same sides of the two reference pictures, the decoding process 1300 decodes the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

In an embodiment, in response to two uni-predictions being available for the current block, the decoding process 1300 decodes the current block by predicting the part of the current block based on a comparison of sizes of two OOB areas each corresponding to one of the two uni-predictions. In response to the sizes of the two OOB areas corresponding to the two uni-predictions being the same, the decoding process 1300 decodes the current block by predicting the part of the current block based on one of the two uni-predictions that is predetermined.

In an embodiment, the decoding process 1300 determines that at least one of MPDMVR tool or BDOF tool is disallowed for the current block.

In an embodiment, the two reference pictures are the same reference picture.

In an embodiment, the two reference pictures are different reference pictures.

### IX. Encoding Flowchart

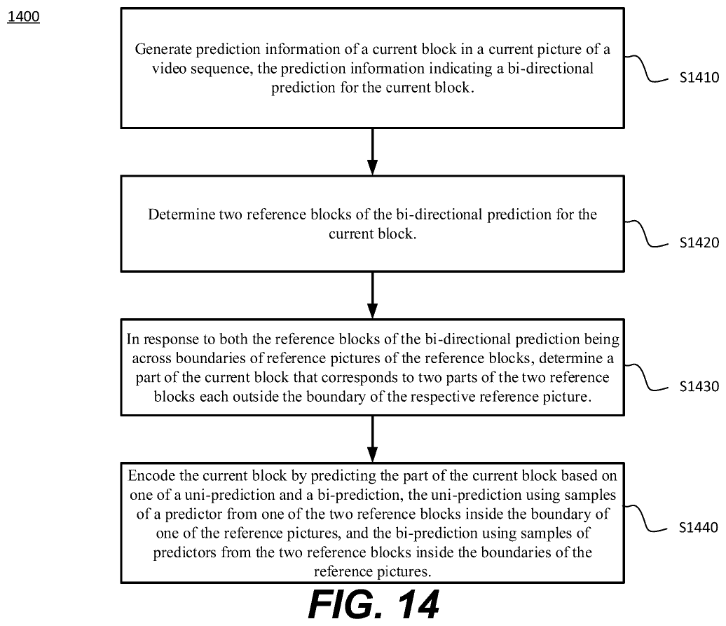

FIG. 14 shows a flow chart outlining an encoding process 1400 according to embodiments of the disclosure. The encoding process 1400 can be used in encoding a to-be-encoded block using a bi-prediction with OOB. In various embodiments, the encoding process 1400 can be executed by processing circuitry, such as CPU 341 and/or GPU 342 of the computer system 300. In some embodiments, the encoding process 1400 is implemented in software instructions, thus when the processing circuitry executes the software instructions, the processing circuitry performs the encoding process 1400. The encoding process can start at S1410.

At step S1410, the encoding process 1400 generates prediction information of a current block in a current picture of a video sequence. The prediction information indicates a bi-directional prediction for the current block. Then, the encoding process 1400 proceeds to step S1420.

At step S1420, the encoding process 1400 determines two reference blocks of the bi-directional prediction for the current block. Then, the encoding process 1400 proceeds to step S1430.

At step S1430, in response to both the reference blocks of the bi-directional prediction being across boundaries of reference pictures of the reference blocks, the encoding process 1400 determines a part of the current block that corresponds to two parts of the two reference blocks each outside the boundary of the respective reference picture. Then, the encoding process 1400 proceeds to step S1440.

At step S1440, the encoding process 1400 encodes the current block by predicting the part of the current block based on one of a uni-prediction and a bi-prediction. The uni-prediction uses samples of a predictor from one of the two reference blocks inside the boundary of one of the reference pictures, and the bi-prediction uses samples of predictors from the two reference blocks inside the boundaries of the reference pictures. Then, the encoding process 1400 terminates.

In an embodiment, the encoding process 1400 determines whether one of the two reference blocks is across a corner of the reference picture of the one of the two reference blocks. In response to one of the two reference blocks being across the corner of the reference picture of the one of the two reference blocks, the encoding process 1400 encodes the current block by predicting the whole current block based on the bi-prediction using the samples of the predictors from the two reference blocks inside the boundaries of the reference pictures.

In an embodiment, the encoding process 1400 determines whether the boundaries of the two reference pictures that the two reference blocks are across are at different sides of the two reference pictures. In response to the boundaries of the two reference pictures that the two reference blocks are across being at different sides of the two reference pictures, the encoding process 1400 encodes the current block by predicting the whole current block based on the bi-prediction using the samples of the predictors from the two reference blocks inside the boundaries of the reference pictures. In response to the boundaries of the two reference pictures that the two reference blocks are across being at the same sides of the two reference pictures, the encoding process 1400 encodes the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

In an embodiment, in response to two uni-predictions being available for the current block, the encoding process 1400 encodes the current block by predicting the part of the current block based on a comparison of sizes of two OOB areas each corresponding to one of the two uni-predictions. In response to the sizes of the two OOB areas corresponding to the two uni-predictions being the same, the encoding process 1400 encodes the current block by predicting the part of the current block based on one of the two uni-predictions that is predetermined.

In an embodiment, the encoding process 1400 determines that at least one of MPDMVR tool or BDOF tool is disallowed for the current block.

In an embodiment, the two reference pictures are the same reference picture.

In an embodiment, the two reference pictures are different reference pictures.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video decoding at a decoder, comprising:
decoding prediction information of a current block in a current picture of a video sequence, the prediction information indicating a bi-directional prediction for the current block;
determining two reference blocks of the bi-directional prediction for the current block;
in response to both the reference blocks of the bi-directional prediction being across boundaries of reference pictures of the reference blocks,
determining a part of the current block that corresponds to two parts of the two reference blocks each outside the boundary of the respective reference picture; and
decoding the current block by predicting the part of the current block based on one of a uni-prediction and a bi-prediction, the uni-prediction using samples of a predictor from one of the two reference blocks inside the boundary of one of the reference pictures, and the bi-prediction using samples of predictors from the two reference blocks inside the boundaries of the reference pictures.

2. The method of claim 1, wherein the decoding comprises:
determining whether one of the two reference blocks is across a corner of the reference picture of the one of the two reference blocks; and
in response to one of the two reference blocks being across the corner of the reference picture of the one of the two reference blocks,
decoding the current block by predicting the whole current block based on the bi-prediction using the samples of the predictors from the two reference blocks inside the boundaries of the reference pictures.

3. The method of claim 1, wherein the decoding comprises:
determining whether the boundaries of the two reference pictures that the two reference blocks are across are at different sides of the two reference pictures; and
in response to the boundaries of the two reference pictures that the two reference blocks are across being at different sides of the two reference pictures,
decoding the current block by predicting the whole current block based on the bi-prediction using the samples of the predictors from the two reference blocks inside the boundaries of the reference pictures.

4. The method of claim 3, further comprising:
in response to the boundaries of the two reference pictures that the two reference blocks are across being at the same sides of the two reference pictures,
decoding the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

5. The method of claim 1, wherein the decoding comprises:
in response to two uni-predictions being available for the current block,
decoding the current block by predicting the part of the current block based on a comparison of sizes of two out-of-boundary (OOB) areas each corresponding to one of the two uni-predictions.

6. The method of claim 5, further comprising:
in response to the sizes of the two OOB areas corresponding to the two uni-predictions being the same,
decoding the current block by predicting the part of the current block based on one of the two uni-predictions that is predetermined.

7. The method of claim 1, further comprising:
determining that at least one of multi-pass decoder-side motion vector refinement (MPDMVR) tool or bi-directional optical flow (BDOF) tool is disallowed for the current block.

8. An apparatus for video decoding, comprising:
processing circuitry configured to:
decode prediction information of a current block in a current picture of a video sequence, the prediction information indicating a bi-directional prediction for the current block;
determine two reference blocks of the bi-directional prediction for the current block;
in response to both the reference blocks of the bi-directional prediction being across boundaries of reference pictures of the reference blocks,
determine a part of the current block that corresponds to two parts of the two reference blocks each outside the boundary of the respective reference picture; and
decode the current block by predicting the part of the current block based on one of a uni-prediction and a bi-prediction, the uni-prediction using samples of a predictor from one of the two reference blocks inside the boundary of one of the reference pictures, and the bi-prediction using samples of predictors from the two reference blocks inside the boundaries of the reference pictures.

9. The apparatus of claim 8, wherein the processing circuitry is configured to:
determine whether one of the two reference blocks is across a corner of the reference picture of the one of the two reference blocks; and
in response to one of the two reference blocks being across the corner of the reference picture of the one of the two reference blocks,
decode the current block by predicting the whole current block based on the bi-prediction using the samples of the predictors from the two reference blocks inside the boundaries of the reference pictures.

10. The apparatus of claim 8, wherein the processing circuitry is configured to:
determine whether the boundaries of the two reference pictures that the two reference blocks are across are at different sides of the two reference pictures; and
in response to the boundaries of the two reference pictures that the two reference blocks are across being at different sides of the two reference pictures,
decode the current block by predicting the whole current block based on the bi-prediction using the samples of the predictors from the two reference blocks inside the boundaries of the reference pictures by predicting the remaining part of the current block based on at least one of the uni-prediction or the bi-prediction.

11. The apparatus of claim 10, wherein the processing circuitry is configured to:
in response to the boundaries of the two reference pictures that the two reference blocks are across being at the same sides of the two reference pictures,
decode the current block by predicting the part of the current block based on the uni-prediction using the samples of the predictor from one of the two reference blocks inside the boundary of one of the reference pictures, by predicting the remaining part of the current block based on at least one of the uni-prediction or the bi-prediction.

12. The apparatus of claim 8, wherein the processing circuitry is configured to:
in response to two uni-predictions being available for the current block,
decode the current block by predicting the part of the current block based on a comparison of sizes of two out-of-boundary (OOB) areas each corresponding to one of the two uni-predictions.

13. The apparatus of claim 12, wherein the processing circuitry is configured to:
In response to the sizes of the two OOB areas corresponding to two uni-predictions being the same,
decode the current block by predicting the part of the current block based on one of the two uni-predictions that is predetermined.

14. The apparatus of claim 8, wherein the processing circuitry is configured to:
determine that at least one of multi-pass decoder-side motion vector refinement (MPDMVR) tool or bi-directional optical flow (BDOF) tool is disallowed for the current block.

15. A method of video encoding at an encoder, comprising:
generating prediction information of a current block in a current picture of a video sequence, the prediction information indicating a bi-directional prediction for the current block;
determining two reference blocks of the bi-directional prediction for the current block;
in response to both the reference blocks of the bi-directional prediction being across boundaries of reference pictures of the reference blocks,
determining a part of the current block that corresponds to two parts of the two reference blocks each outside the boundary of the respective reference picture; and
encoding the current block by predicting the part of the current block based on one of a uni-prediction and a bi-prediction, the uni-prediction using samples of a predictor from one of the two reference blocks inside the boundary of one of the reference pictures, and the bi-prediction using samples of predictors from the two reference blocks inside the boundaries of the reference pictures.

16. The method of claim 15, wherein the encoding comprises:
determining whether one of the two reference blocks is across a corner of the reference picture of the one of the two reference blocks; and
in response to one of the two reference blocks being across the corner of the reference picture of the one of the two reference blocks,
encoding the current block by predicting the whole current block based on the bi-prediction using the samples of the predictors from the two reference blocks inside the boundaries of the reference pictures.

17. The method of claim 15, wherein the encoding comprises:
determining whether the boundaries of the two reference pictures that the two reference blocks are across are at different sides of the two reference pictures; and
in response to the boundaries of the two reference pictures that the two reference blocks are across being at different sides of the two reference pictures,
encoding the current block by predicting the part of the current block based on the bi-prediction using the samples of the predictors from the two reference blocks inside the boundaries of the reference pictures.

18. The method of claim 17, further comprising:
in response to the boundaries of the two reference pictures that the two reference blocks are across being at the same sides of the two reference pictures,
encoding the current block by predicting the part of the current block based on the uni-prediction using the samples of the predictor from one of the two reference blocks inside the boundary of one of the reference pictures, and by predicting the remaining part of the current block based on at least one of the uni-prediction or the bi-prediction.

19. The method of claim 15, wherein the decoding comprises:
in response to two uni-predictions being available for the current block,
encoding the current block by predicting the part of the current block based on a comparison of sizes of two out-of-boundary (OOB) areas each corresponding to one of the two uni-predictions.

20. The method of claim 19, further comprising:
in response to the sizes of the two OOB areas corresponding to the two uni-predictions being the same,
encoding the current block by predicting the part of the current block based on one of the two uni-predictions that is predetermined.
